(19) United States
(12) Patent Application Publication
(10) Pub. No.: US 2003/0098842 A1
(43) Pub. Date: May 29, 2003

(54) Directional switch

(75) Inventors: Chin-Wen Chou, Hsin-Tien City (TW); Tsui-Jung Su, Hsin-Tien City (TW); Chien-Hao Su, Hsin-Tien City (TW)

Correspondence Address: BACON & THOMAS, PLLC, 625 SLATERS LANE, FOURTH FLOOR, ALEXANDRIA, VA, 22314

(73) Assignee: SHIN JIUH CORP., Taipei Hsien (JP)

(21) Appl. No.: 09/993,567

(22) Filed: Nov. 27, 2001

(51) Int. Cl. G09G 5/00

(52) U.S. Cl. 345/156

(57) ABSTRACT

An improved directional switch mainly utilizes a piece of elastic member to form a single elastic structure to couple with a conductive member to construct a small size directional switch that is easy to assemble. The structure includes a base block coupling with a lid, and a control unit and the conductive member located in the bas block. The base block has contact terminals and a common contact terminal located at the bottom thereof. Applying a force on the control unit to depress the conductive member, the conductive member will be moved downwards to connect one contact terminal and the common contact terminal to output a directional signal.

### FIELD OF THE INVENTION

The present invention relates to an improved directional switch and particularly a directional switch that is small size and easy to assemble.

### BACKGROUND OF THE INVENTION

The rapid technology innovation and development have made many producers focusing the design of electronic products on enhancing versatility and muti-functionality. The flourishing of electronic commerce in recent years and growing popularity of the Internet applications also accelerate information communication and give users great convenience. These days, many electronic products, in addition to personal computers and notebook computers, such as mobile phones, household phones and the like have equipped with a display screen to allow users selecting multiple function through cursors (such as access the Internet, modify or enter data, inquire and search stored telephone numbers, etc.). However the directional keys and execution keys on conventional electronic products for users operation mostly consist of a plural number of independent switches. Such a design occupies too much space and is difficult to produce. Operation is also quite complicated. To develop a directional control switch for modularizing the switch to a single element can shrink the size of the switch and make operation easier. It becomes a highly pursuing goal in the industry nowadays.

Applicant submitted a patent application on Jun. 28, 2000 at application Ser. No. 09/606198 entitled “Directional control switch module” to address this concern. That patent application mainly includes a base block containing a common contact terminal and contact terminals, a control unit containing a depressing block and an axle rod, and a lid to allow the axle rod to pass through. There are a plurality of elastic members located between the control unit and the common contact terminal and contact terminals. Applying a force on the axle rod in a selected direction, the depressing block will be moved to depress an elastic element which may connect one contact terminal, thereby a directional signal will be output to control the cursor moving to a desired position for execution.

In the prior art set forth above, the directional switch has a plurality of elastic members that might have different elasticity due to manufacturing deviation. As a result, their touching sensitivity could be different. Moreover, the base block must hold multiple number of elastic members and takes a lot of space, thus it is difficult to shrink the total size of the switch. Furthermore, additional steps have to be included in the assembly and will result in higher production costs. In addition, the depressing block is directly pressed on the metallic elastic members. After depressing repeatedly for a prolonged period of time, the metallic elastic members are prone to wear off and cause malfunction. As the depressing block consists of a sphere element and depressing blades extending to four ends, the depressing blades also are prone to rupture after repeatedly depressing. While a reinforced plate may be added to augment the strength, it is still a structural deficiency and requires remedy.

### SUMMARY OF THE INVENTION

In view of the foregoing disadvantages, the primary object of the invention is to provide an improved directional switch that has a lid and a base block coupled together to form a housing section inside. The housing section contains an elastic member and a control unit. The control unit includes an axle rod, a depressing block, a lining pad and a conductive member. The construction may be made in a small size and is easy to assemble.

Another object of the invention is to provide an elastic member on the common contact terminal and a conductive member to give the axle rod and depressing block a restoring force to form a single elastic structure thereby to reduce element number and shrink the size of the switch and lower the cost.

A further object of the invention is to provide an elastic member on the common contact terminal and a conductive member to give the axle rod and depressing block a restoring force to form a single elastic structure thereby to reduce element number and improve assembly process and to make assembly easier.

Yet another object of the invention is to provide a lining pad between the conductive member and depressing block to prevent the depressing block from directly contact the conductive member thereby to reduce metal wearing and improve the product quality and enhance product durability.

Still another object of the invention is to provide reinforced sections on the depressing block on the top surface thereof extending from an axle opening to save the reinforced plate in the prior art. The depressing block and axle rod further have respectively a retain recess and a retain flange to couple with each other to allow the axle rod securely held in the axle opening and provide the axle rod a moving space when depressed downwards to attain more precise function.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional directional switch.

FIG. 2 is a prospective view of the invention.

FIGS. 3 and 4 are exploded views of the invention.

FIGS. 5A, 5B and 5C are cross sections taken along line 5A-5A in FIG. 2, showing the invention in use under different conditions.

FIG. 6 is another cross section of the invention in use, under another condition.

FIG. 7 is a schematic view of an embodiment configuration of the common contact terminal and contact terminals of the invention.

FIG. 8 is a pictorial view of an embodiment of the invention.

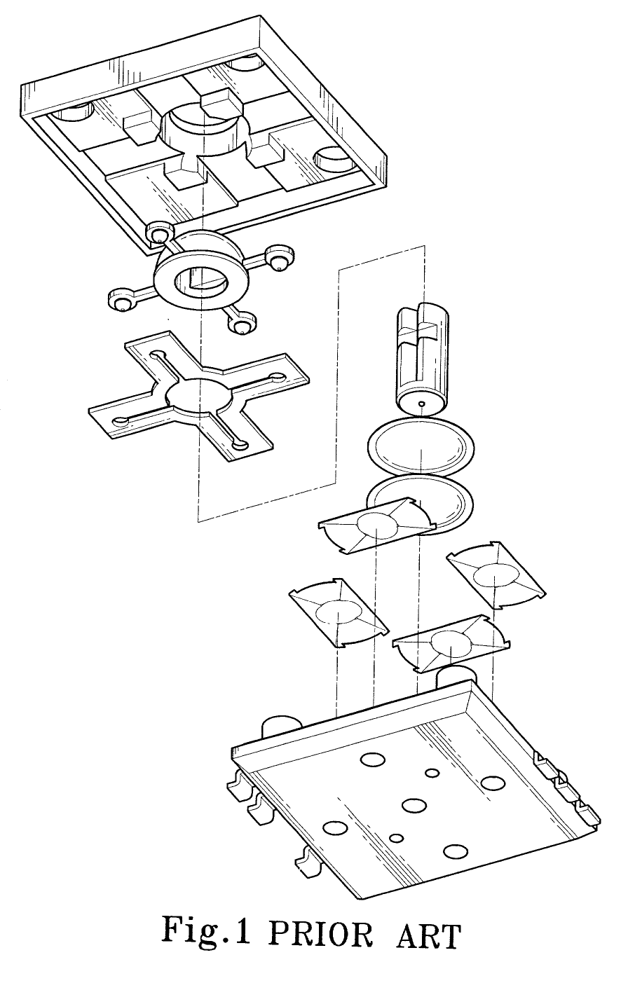

### DESCRIPTION OF THE PREFERRED EMBODIMENT

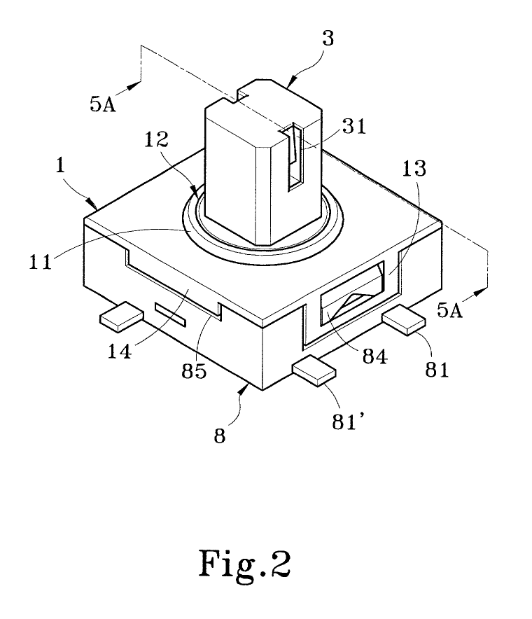

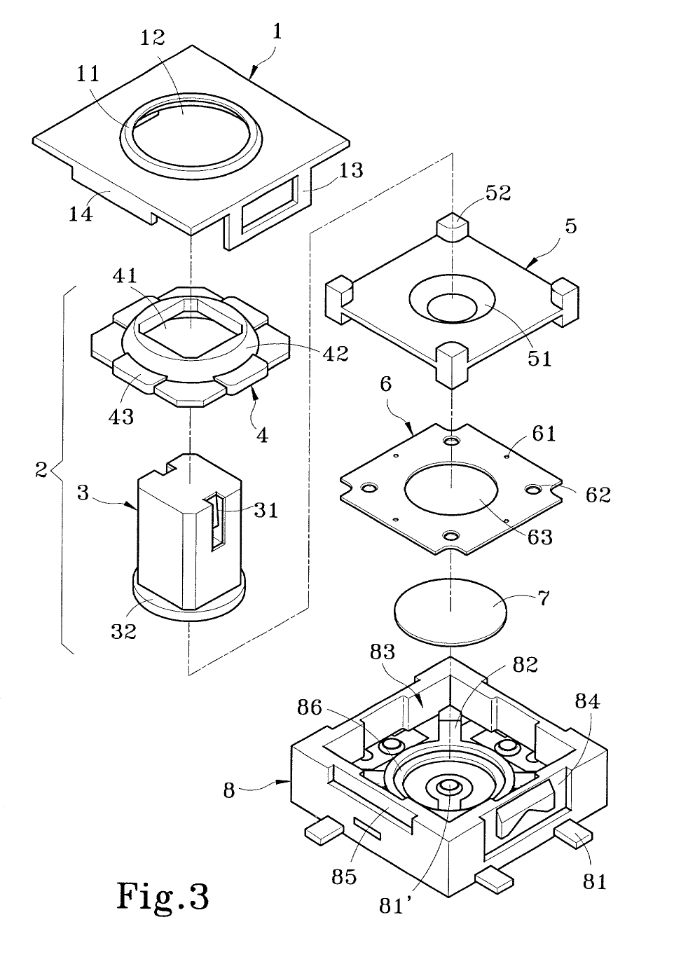

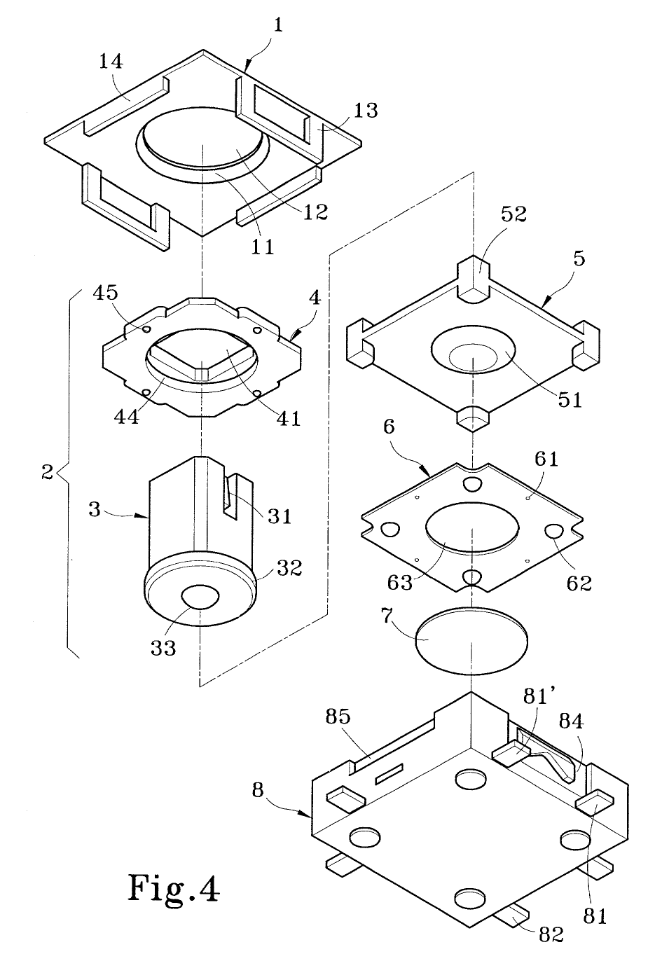

Referring to FIGS. 2, 3 and 5 for an embodiment of the invention, the invention is adapted for use in electronic products such as a mobile phone 9, household telephones or personal computers, notebook computers that have operation keyboards for controlling the cursor displacement. It mainly includes a lid 1 coupling with a base block 8. The base block 8 has a housing section 83 to hold an elastic member 7 and a control unit 2.

The lid 1 has a latch section 13 and an anchor section 14 matching and engageable with a latch trough 84 and an anchor trough 85 formed on the base block 8 for the two to couple together. The housing section 83 of the base block 8 has a bottom with four ends and a center disposed with a plurality of contact terminals 81, 81′ in various directions for generating different circuit signals. There is common contact terminal 82 surrounding the contact terminals 81, 81′. At the center, there is also a holding trough 86 for holding the elastic member 7. The lid 1 further has a center opening 12 formed on an inner side and an operation trough 11 to allow the control unit 2 passing through.

The control unit 2 includes a depressing block 4 which has an operation section 42 and a square axle opening 41 matching the operation trough 11 of the lid 1, and a square axle rod 3 passing through the axle opening 41 and the center opening 12 of the lid 1. The depressing block 4 and axle rod 3 have respectively a round retain recess 44 and a round retain flange 32 matching each other. The axle rod 3 passes through the axle opening 41 and engages therewith securely because of the round retain recess 44 being coupled with the round retain flange 32. The bottom of the axle rod 3 has a first depress spot 33 in the center and the bottom of the depressing block 4 have second depress spots 45 corresponding to the contact terminals 81. The top surface of the depressing block 4 has reinforced sections 43 extending from the axle opening 41 to the second depress spots 45 to increase the depressing strength of the depressing block.

In addition, beneath the bottom of the depressing block 4, there is a lining pad 5 that has an indented section 51 in the center and struts 52 located at four ends. Beneath the bottom of the lining pad 5, there is an elastic conductive member 6 that has a plurality of pressing spots 61 matching the contact terminals 81 of the base block 8 and an operation opening 63 for housing the indented section 51 of the lining pad 5. The conductive member 6 further may connect the common contact terminal 82 located in the housing section 83 (or the conductive member 6 may be spaced from the common contact terminal 82 and connect therewith when depressed), and also has conducting sections 62 of a selected height.

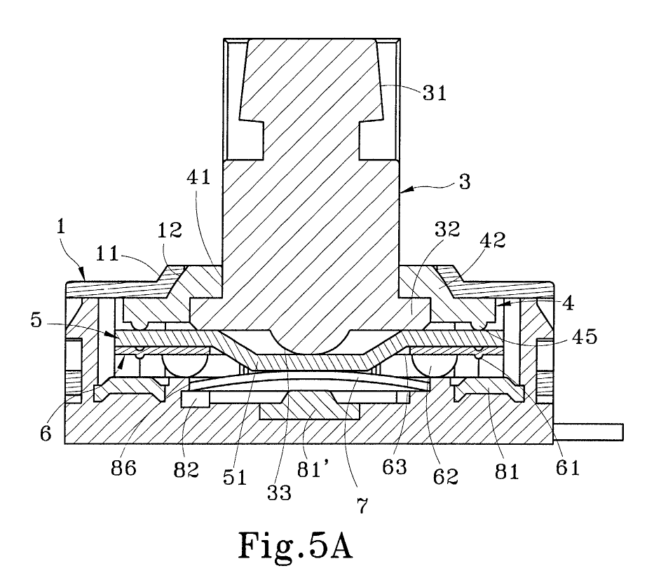

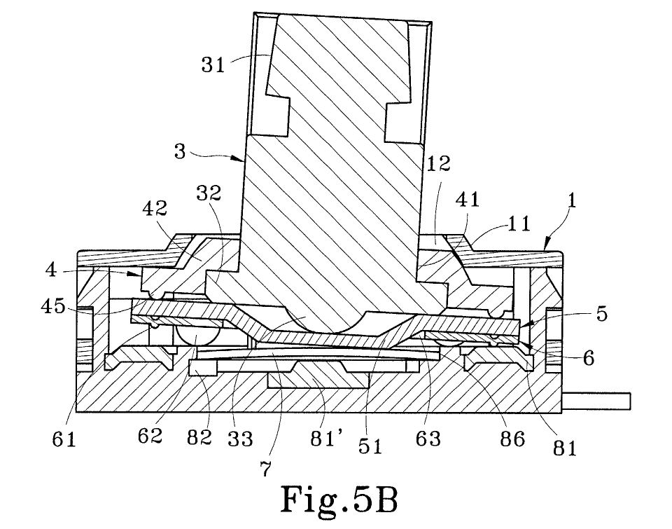

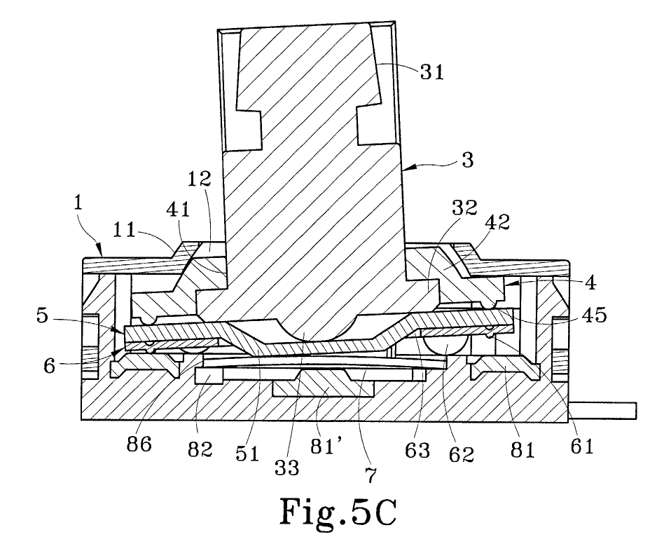

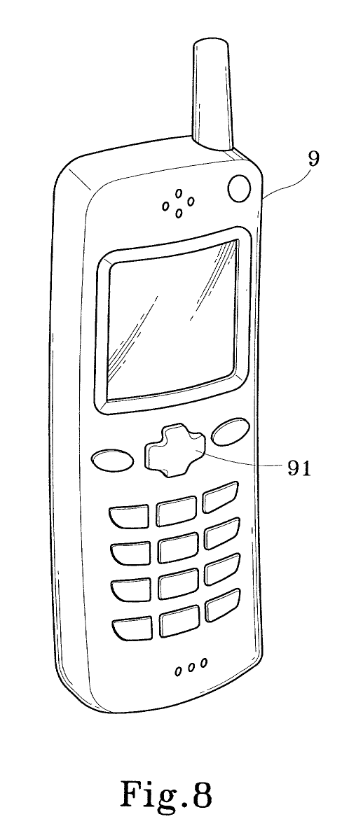

Referring to FIGS. 5A and 5B, when the invention is assembled and in use, the axle rod 3 has a set of fasten trough 31 to engage with a direction control element 91 on a mobile phone 9 as shown in FIG. 8. When an user wants to control and move the cursor to a selected location, applying a force on the direction control element 91 (such as moving rightwards) to drive the axle rod 3 moving to the right direction in the center opening 12, the operation section 42 of the depressing block 4 will be tilted rightwards in the operation trough 11 of the lid 1, in the mean time, the second depress spot 45 at the bottom of the depressing block 4 will depress the lining pad 5 and conductive member 6 below. As a result, the right hand side of the lining pad 5 and conductive member 6 will be bent and deformed, and the pressing spot 61 of the conductive member 6 is depressed and connects the contact terminal 81 on the right hand side. As the conducting section 62 of the conductive member 6 is connected to the common contact terminal 82 when assembled, the connection of the pressing spot 61 and the contact terminal 81 forms a circuit from the contact terminal 81 through the conductive member 6 to the common contact terminal 82, and may output a directional signal, therefore the cursor will be moved to a selected location for execution (FIG. 5C shows the cursor being moved towards another direction, its operation principle is same as what have been discussed above, thus will be omitted here).

In addition, when a user depresses in various directions, the elastic member 7 below the axle rod 3 will be depressed by the lining pad 5 and deformed slightly and generates a touch sense. After the user finishing operation, the restoring force stored in the bent elastic member 7 and conductive member 6 will push and return the axle rod 3 and depressing block 4 to their initial positions for next cycle operation.

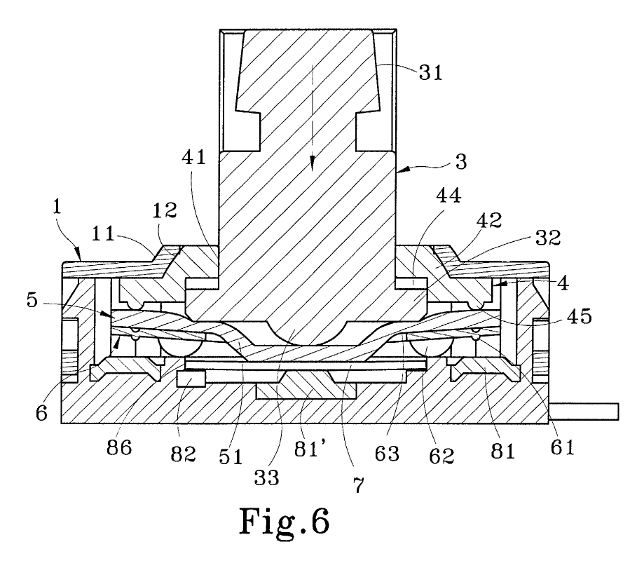

Referring to FIG. 6, when a force is applied on the center of the direction control element 91, the retain flange 32 of the axle rod 3 will be moved downwards in the retain recess 44 of the depressing block 4, the first depress spot 33 at the bottom of the axle rod 3 will depress the indented section 51 of the lining pad 5 through the operation opening 63 of the conductive member 6 to make the elastic member 7 which is already connected to the common contact terminal 82 connecting the contact terminal 81′ located in the housing section 83 and output an execution signal (or a selection signal). After the user finishing the operation of moving the cursor for executing a selected command, the stored force of the bent elastic member 7 will push and return the axle rod 3 to its initial position for next cycle operation.

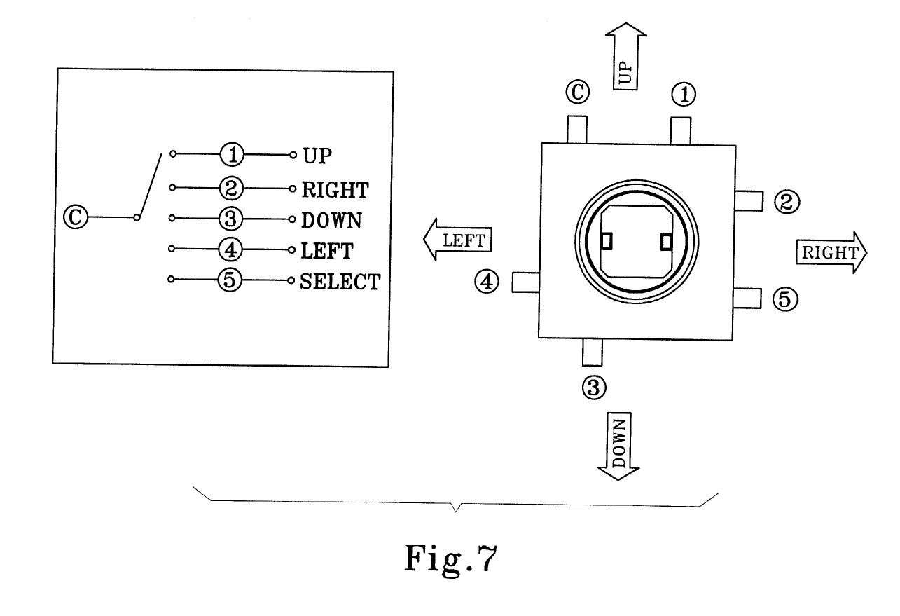

Referring to FIG. 7 for a schematic view of an embodiment configuration of common contact terminal and contact terminals of the invention, it clearly indicates that the common contact terminal 82 and contact terminals 81 can be linked in selected configurations to form circuits for generating various direction or execution signals.

What is claimed is:

1. An improved directional switch, comprising:
a base block having a housing section which has four ends and a center disposed with a plurality of contact terminals and a common contact terminal in various directions for generating different circuit signals, and an elastic member located above the common contact terminal;
a control unit located in the housing section including a conductive member located above the elastic member, a depressing block located above the conductive member and an axle rod passing through the depressing block, the conductive member having pressing spots and conducting section matching the contact terminals and common contact terminal; and
a lid encasing the control unit and coupling with the base block, and having a center opening to allow the axle rod passing through;
wherein the axle rod is movable in a selected direction by force to drive the depressing block depressing the conductive member such that the pressing spots and conducting section are moved downwards to connect one contact terminal and the common contact terminal for outputting a directional signal thereby to function as a directional switch of a small size.

2. The improved directional switch of claim 1, wherein the depressing block has an axle opening to allow the axle rod passing through and a retain recess to engage with a retain flange formed on the axle rod.

3. The improved directional switch of claim 1, wherein the base block and the lid have respectively a latch trough and a latch section engageable with each other.

4. The improved directional switch of claim 1, wherein the base block and the lid have respectively an anchor trough and an anchor section engageable with each other.

5. The improved directional switch of claim 1 further having a lining pad located between the depressing block and the elastic member, the lining pad having four ends each having a strut and a center which has an indented section, the conductive member having an operation opening for the indented section to pass through.

6. The improved directional switch of claim 1, wherein the depressing block and the lid have respectively an operation section and an operation trough located on an inner lateral side matching with each other.

7. The improved directional switch of claim 1, wherein the depressing block has the second depress spots corresponding to the pressing spots.

8. The improved directional switch of claim 7, wherein the depressing block has reinforced sections located on the top surface thereof extending from the axle opening to the second depress spots.

9. The improved directional switch of claim 1, wherein the housing section has a holding trough for holding the elastic member.

10. The improved directional switch of claim 1, wherein the axle rod has a fasten trough for coupling with a direction control element of a mobile phone.
